(19) United States
(12) Patent Application Publication
(10) Pub. No.: US 2001/0047618 A1
(43) Pub. Date: Dec. 6, 2001

(54) Lighting apparatus capable of adjusting light quality, duty ratio and frequency in a plant growth chamber using light emitting diodes

(76) Inventors: Wei Fang, Taipei (TW); Rueychi Jao, Taipei Hsien (TW); Den Hua Lee, Hsinchu (TW)

Correspondence Address: BIRCH STEWART KOLASCH & BIRCH, PO BOX 747, FALLS CHURCH, VA, 22040-0747, US

(21) Appl. No.: 09/833,562

(22) Filed: Apr. 13, 2001

(30) Foreign Application Priority Data
May 30, 2000 (TW) 89209209

(51) Int. Cl. A01G 9/02

(52) U.S. Cl. 47/65.5

(57) ABSTRACT

A plant growth apparatus that includes a chamber with multiple layers, a driver and at least one lamp per layer provided in the chamber. The lamp includes a plurality of high intensity red light emitting diodes and a plurality of blue light emitting diodes. The red and blue light emitting diodes are alternately arranged. The driver is capable of individually controlling the intensity of red and blue light, thus, leading to the capability of controlling the light quality. The driver is also capable of controlling the frequency and duty ratio of direct current provided to the red and blue light emitting diodes during the light-period of the photoperiod controlled by the timer.

### BACKGROUND OF THE INVENTION

1. Field of the Invention

The present invention relates in general to a plant growth chamber equipped with one or more layers of lighting apparatus using high intensity red light emitting diodes (LEDs) and blue LEDs as a mixed light source organized in a plate-shape format. In particular, the light quantity, light quality, duty ratio and frequency of the lighting cycle during the photoperiod of the present invention are adjustable.

2. Description of the Related Art

Plant growth chambers are basic tools for plant related researchers and plant-seedling producers. Traditionally, tubular fluorescent lamps (TFLs) were used as artificial light source in plant growth chambers. The purpose of TFL in growth chambers is to mimic the sun. However, the sun provides continuous light and the TFLs using alternate current provide flickering light at 50 Hz or 60 Hz frequency. The capability to mimic the sun is important in certain researches but not all. The LEDs with direct current can provide continuous light. The excess heat generated by the TFLs if not removed will injure the cultured plants, thus leading to extra cooling costs. Also, due to the same reason, only few layers can be arranged in the chamber, leading to low vertical space utilization and high cost per unit area utilized. LEDs will not generate excess heat, thus, the vertical space of the chamber can be separated into more layers compare with the chambers using TFLs. The necessity of cooling can be reduced greatly as well. The light quantity and quality are fixed as long as the TFLs were installed. A plant growth chamber with the capability of adjusting the light quantity and quality without changing the number and type of light source will provide great flexibility to researchers. Recently, such plant growth chambers have been commercially available worldwide. However, all these chambers failed to provide the capability of adjusting frequency and duty ratio of the light source.

The reasons to develop light source with the capability of adjusting frequency and duty ratio are as follows:

1. From the energy saving point of view: TFLs are normally at 50 or 60 hz, providing 100 or 120 pulse light per second. A photoperiod of 16 hours using TFLs will be charged for 16 hours of electricity fees. From the on/off cycling point of view, LEDs using direct current provide continuous light. With a 50% duty ratio and a frequency of 120 will have similar effect of TFLs at 60 Hz. Yet, only half of the electricity consumed by the LEDs if the power consumed in generating the on/off cycling is ignored. The duty ratio is defined as the ratio of duration time of ‘on’ vs. the duration time of ‘on’ plus ‘off’ in one period. One minus duty ratio is the proportion of electricity saved.

2. To provide various duty ratio and high frequency: Photosynthesis can be separated into light and dark reactions. In these reactions, the duration times are not the same. Researchers require high frequency pulse light (from micro (10⁻⁶) to nano (10⁻⁹) seconds duration time) to study the electron transfer and required a different duration time (0.02 second for example) of dark period to study the enzyme behavior and the fixation of CO₂. Using regular and high frequency TFLs can only provide 60 Hz/16 mini (10⁻³) seconds and 37 kHz/0.27 micro seconds, respectively. Also, TFL use alternate current and the duration times for ‘on’ and ‘off’ are approximately equal, thus, leading to a duty ratio of 0.5 and it is not changeable. The LEDs can be provided with pulse direct current in high frequency with the help of controlling IC and the duration time of ‘on’ and ‘off’ can be different as long as the setting of the duty ratio does not equal to 0.5.

### SUMMARY OF THE INVENTION

The present invention adapts LEDs to a plant growth apparatus for culturing plants. The plant growth apparatus of the present invention includes a chamber with at least one layer, a driver and at least one lamp provided in the chamber. Outside of the chamber are setting and indicating devices served as the user interface to the hardware. The lamp includes a plurality of high intensity red and blue LEDs, arranged alternately. The driver is capable of individually control the blue and red LEDs' light intensity, thus, controlling the light quality (amount of red vs. blue light) of the lamp. Also, the same driver is capable of controlling the frequency and duty ratio of both LEDs during the light period of the photoperiod. The present invention provided with both capabilities mentioned above, making it a great tool for researchers related to photosynthesis, photomorphogenesis and other light related plant physiologies.

### BRIEF DESCRIPTION OF THE DRAWINGS

The present invention can be more fully understood by reading the subsequent detailed description and examples with references made to the accompanying drawings, wherein:

FIG. 1 is a perspective diagram of a plant growth apparatus of the present invention.

FIG. 2 depicts an arrangement of LEDs on a circuit board of a lamp of the present invention.

FIG. 3 is a block diagram of a driver of the plant growth apparatus of the present invention.

### DETAILED DESCRIPTION OF THE PREFERRED EMBODIMENT

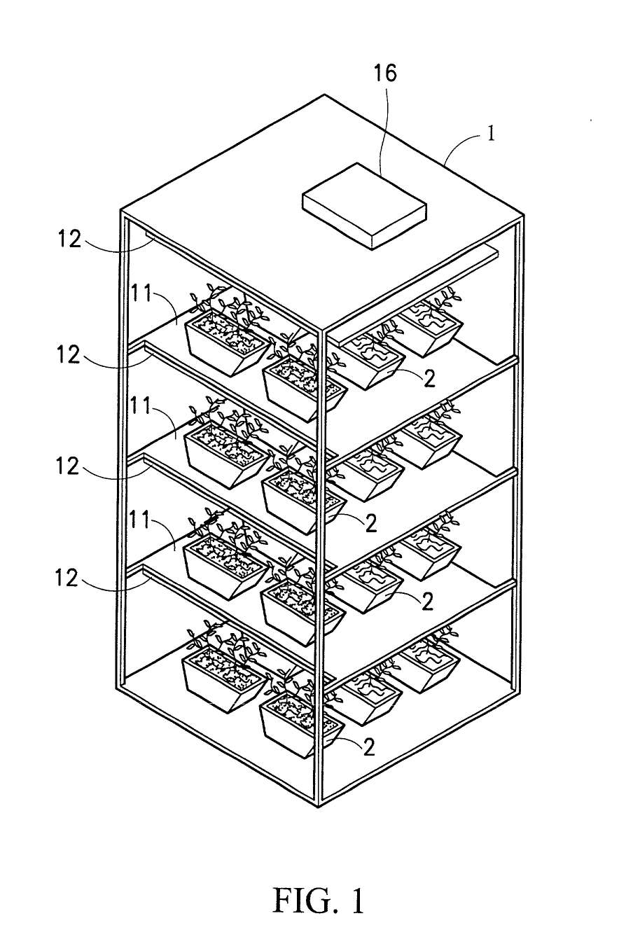

Referring to FIG. 1, a plant growth apparatus 1 of the present invention has a chamber and partitions 11 to create a plurality of layers inside the chamber. On the ceiling of each layer is mounted a lamp 12. The lamp 12 is a mixed light source including high intensity red and blue LEDs. Cultured plants 2 are provided under the lamp 12. Furthermore, a driver 16 is mounted on the top of the plant growth apparatus 1. The driver 16 is used for adjusting the voltage, current, frequency and duty ratio of the direct currents sent to the red and blue LEDs separately from a power supply (not shown), thereby controlling the light quantity, light quality and lighting cycle of the lamps 12.

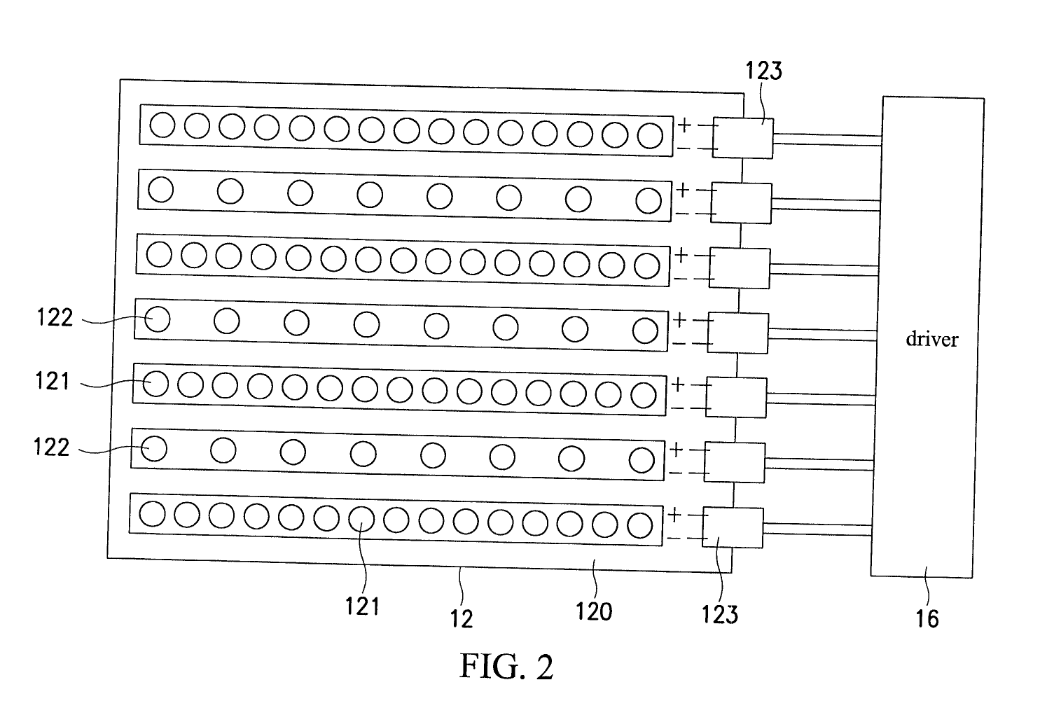

Referring to FIG. 2, the lamp 12 has a circuit board 120 on which a plurality of rows of high intensity red LEDs 121 and a plurality of rows of blue LEDs 122 are mounted. It is noted that the rows of high intensity red LEDs 121 and the rows of blue LEDs 121 are alternately arranged. That is, next to a row of high intensity red LEDs 121 is a row of blue LEDs 122, and vice versa. Furthermore, the high intensity red LEDs 121 in each row are spaced a distance smaller than the distance that the blue LEDs 122 are spaced. There are twice as many high intensity red LEDs 121 as blue LEDs 122. Furthermore, the high intensity red LEDs 121 and the blue LEDs 122 are electrically connected to the driver 16 via connectors 123.

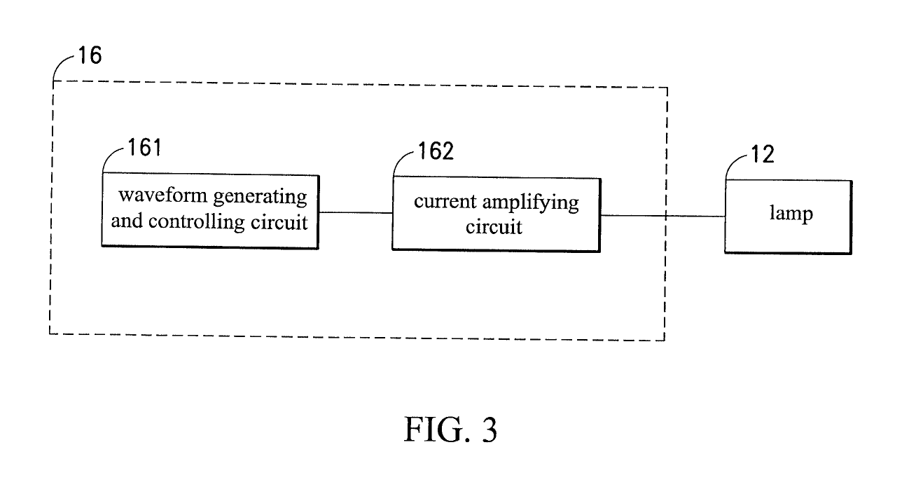

The driver 16 is used for controlling the light quantity, light quality and lighting cycle of the lamps 12. Referring to FIG. 3, the driver 16 includes a waveform generating and controlling circuit 161 and a current amplifying circuit 162. The waveform generating and controlling circuit 161 outputs the desired waveform (e.g. square waves, triangular waves, sine waves, cosine waves and pulses, etc.). Also, the waveform's amplitude, frequency and duty ratio are adjustable by the waveform generating and controlling circuit 161. Then, the waveform is amplified by the current-amplifying circuit 162 and sent to the lamps 12 to control the lamps, light quantity, light quality and lighting cycle. The amount of frequency, duty ratio and current are shown in separate devices attached outside of the chamber (not shown).

The plant growth apparatus of the present invention is developed for the research purpose mainly. Researchers can use the plant growth apparatus of the present invention to find the optimal light quantity and light quality for the growth of various plants, and to assess the acceptable frequency and duty ratio during the photoperiod for the purpose of either energy savings and/or better growth rate of the plants.

While the invention has been described by way of example and in terms of the preferred embodiment, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A plant growth apparatus including:
a chamber;
at least one lamp provided in the chamber, the at least one lamp including a plurality of first light emitting diodes and a plurality of second light emitting diodes, wherein the first and second light emitting diodes are alternately arranged.

2. A plant growth apparatus as claimed in claim 1, wherein the first light emitting diodes are high intensity red light emitting diodes, and the second light emitting diodes are blue light emitting diodes.

3. A plant growth apparatus as claimed in claim 2, wherein the high intensity red light emitting diodes are arranged in red rows, the blue light emitting diodes are arranged in blue rows, and the red rows and the blue rows are alternately arranged.

4. A plant growth apparatus as claimed in claim 2, further including a driver for individually controlling the high intensity red light emitting diodes' and the blue light emitting diodes' light quantity, light quality and lighting cycle.

5. A plant growth apparatus as claimed in claim 4, wherein the driver includes a waveform generating and controlling circuit for outputting desired waveform, and a current-amplifying circuit for amplifying the waveform and sending the waveform to the lamp, thereby controlling the lamp's light quantity, light quality and lighting cycle.

6. A plant growth apparatus as claimed in claim 5, wherein the waveform's amplitude, frequency and duty ratio are adjustable by the waveform generating and controlling circuit.
